(19) United States
(12) Patent Application Publication
(10) Pub. No.: US 2014/0310744 A1
(43) Pub. Date: Oct. 16, 2014

(54) POWER MONITORING SYSTEM

(71) Applicant: Embertec Pty Ltd, Dulwich (AU)

(72) Inventor: Domenico Gelonese, Dulwich (AU)

(73) Assignee: Embertec Pty Ltd, Dulwich (AU)

(21) Appl. No.: 14/249,553

(22) Filed: Apr. 10, 2014

(30) Foreign Application Priority Data
Apr. 11, 2013 (AU) 2013203646

(51) Int. Cl. H04N 21/443; H04N 5/44; H04N 21/442; H04N 5/445; H04N 21/41; G06F 1/32

(52) U.S. Cl. CPC H04N 21/4436; H04N 21/4126; G06F 1/3231; G06F 1/3246; H04N 21/44231; H04N 5/445; H04N 5/4403; H04N 2005/44521; H04N 2005/4426
USPC 725/34; 725/133

(57) ABSTRACT

A set top box is configured to detect that a television (or other electrical device) connected to the set top box is not in use, and places the television (or other device) into a lower energy usage state. The set top box includes a controlled power outlet adapted to provide power for the electrical device, a switch adapted to control power to the controlled power outlet, and a sensor adapted to sense at least one characteristic of the power drawn through the controlled power outlet, wherein the switch is operated in response to the sensed characteristic. For example, if the set top box has a television drawing power from the controlled power outlet, and the sensor senses that the television is in a decreased-power “standby” state, the switch may cut power to the controlled power outlet to avoid the parasitic power loss incurred by the standby state.

### FIELD OF THE INVENTION

This invention relates to aspects of digital television receiving devices and associated audio visual and electrical devices with a view to reducing unnecessary energy consumption.

### BACKGROUND OF THE INVENTION

The following references to and descriptions of prior proposals or products are not intended to be and are not to be construed as statements or admissions of common general knowledge in the art. In particular, the following prior art discussion does not relate to what is commonly or well known by the person skilled in the art, but may assist in the understanding of the inventive step of the present invention, of which the identification of pertinent prior proposals is but one part.

There is currently world-wide concern about the level of use of electrical energy for both domestic and commercial uses. In part this concern is based on the greenhouse gas production associated with the generation of the electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to the energy use of households is the audio visual equipment including multiple devices such as televisions, television decoders, television recorders and sound equipment now found in virtually all homes.

Efforts have been made to reduce or control the use of energy by television receivers, and these have met with considerable success. However, the advent of cable and satellite television and digital broadcasting, a further device, the so-called set top box, has become commonplace. This device falls outside many of these energy saving efforts.

### SUMMARY OF THE INVENTION

Accordingly, in a first aspect this invention provides a set top box including means to detect that a television connected to the set top box is not in use, and a means to place the television into a lower energy usage state.

In yet a further aspect of the present invention there is a set top box able to display a video signal on an associated television monitor, the set top box including a controlled power outlet adapted to provide power for the television monitor; and a switch adapted to control power to the controlled power outlet.

In preference the set top box further including a power sensor adapted to sense one or more characteristics of the power drawn through the controlled power outlet and means to determine in which of two power states the television monitor is operating; and a means to operate the switch in response to the determination.

In preference the switch is operated to remove power from the controlled power outlet when the television monitor is determined to be in a lower power standby mode.

In preference the set top box further includes a usage detector adapted to detect operation of a remote control device wherein in use the switch is operated to remove power from the controlled power outlet when the absence of detection of remote control activity is sensed for a predetermined period.

A set top box substantially as described in the specification with reference to and as illustrated by any one or more of the accompanying drawings.

### BRIEF DESCRIPTION OF THE DRAWINGS

Exemplary versions of the invention will now be described with reference to the accompanying drawings in which:

FIG. 1 is a representation of a set top box incorporating the invention.

FIG. 2 is a diagram of a set top box incorporating the invention.

FIG. 3 is a block diagram of the processor function of a set top box of the invention.

FIG. 4 shows a partial block diagram of a system including a set top box incorporating the invention.

### DETAILED DESCRIPTION OF EXEMPLARY VERSIONS OF THE INVENTION

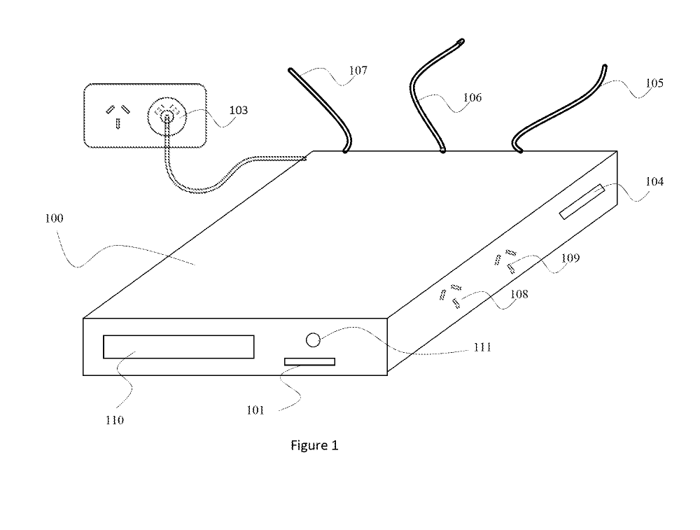

Referring first to FIG. 1, it is to be understood that this is a general representation of a set top box including the invention and is illustrative only. It is not intended to limit the number or configuration of continually powered or switched or monitored main outlets, or of communication interfaces or other functional modules.

FIG. 1 shows a representation of a set top box including a version of the current invention. A set top box (STB) is any device which receives an incoming signal having video information encoded within the signal, and outputs a signal for display by a television screen or other display. The incoming signal may be from a cable or satellite television service or from a terrestrial television broadcast system. The signal may also be received over the internet or any other communication network.

The STB 100 receives electrical power from a General Purpose Outlet 103, via power cord 102. Power is provided by the STB for a television set via Controlled and Monitored electrical outlet 108. Power is also provided to Uncontrolled electrical outlet 109, an optional feature which need not be provided.

The STB receives signals with encoded video information from a cable or satellite television transmission system via cable connector 105. There may also be a terrestrial antenna connection 106 for receiving terrestrial broadcast signals.

The STB is able to communicate via internet protocol (IP) via the Ethernet connection 107.

The STB receives signals with encoded video information from one or more of these connectors and decodes the signal to produce a video signal suitable for display on a television screen or other monitor. In the illustrated version of the invention the video signal is a HDMI signal. There is a HDMI connector 104 for connection to a television to display the output video signal.

The STB includes an infra-red sensor 101 for receiving signals from an infra-red remote control. There is an LCD display 110 for displaying status information such as the identity of the television channel being output.

In order to save energy the STB operates to remove the power supply to Controlled and Monitored outlet 108 and hence from the attached television, whenever the television is detected to not be in use.

Modern television sets and other audio visual equipment, when turned “off” by the remote control, enter a low power “standby” state, in which energy is still consumed, although at a significantly lower level that when the device is nominally “on”. When the television is in this standby state it is not in use, and the power supply to it may be cut to save energy.

It is also the case that television sets may be left on for extended periods when no user is viewing the screen. This may happen when a user falls asleep in front of the television, or when a user, particularly a child or a teenager, simply leaves the vicinity of the television without turning the television off. In this case the television is not in use, and the power supply to it may be cut to save energy.

The STB may detect that the television has entered a standby state by any convenient means or combination of means. The HDMI protocol, and other protocols for communication with monitors, allows for the detection that a connected television or monitor is no longer receiving or displaying the video signal on that HDMI connection. The STB may periodically test the HDMI connection to check whether any connected display device is receiving and displaying the video signal. When no connected device is receiving or displaying the video output, the power to the Controlled and Monitored outlet 108, and hence to the attached television or monitor is interrupted.

The STB may also include a power sensor adapted to sense the power drawn through the controlled power outlet. The power sensor detects characteristics of the power flow through the outlet. When the characteristic is such as to indicate that the television is in a standby mode the power to the Controlled and Monitored outlet 108, and hence to the attached television or monitor is interrupted.

The STB may include multiple controlled power outlets, which may be monitored and controlled individually or together.

The STB may include means to detect that a user is interacting with the STB and/or the television. In the illustrated version of the invention, the IR sensor 101 receives IR signals from the remote control. In addition to decoding the IR signal received from the remote control in order to implement control of the video functions of the STB, the STB uses the usage of the remote control to indicate that a user is present and actively watching the television.

It has been determined that a user, when actively watching television, will periodically use the remote control to change channels, adjust volume, mute commercials, etc. Thus a remote control signal receiver, such as IR sensor 101 can be used as a usage detector. If no remote control activity is detected by the IR sensor 101 for a period of time, the assumption may be made that the television is not in use, and the power supply to the Controlled and Monitored outlet 108, and hence to the television, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero, there has been no remote control activity for the time period, and the television is assumed to not be in active use and the power supply to the Controlled and Monitored outlet 108, and hence to the television, is interrupted.

It is possible that other devices in addition to the STB may be connected to the television, and use the television to display content. Such devices would include DVD players and VCRs. Should these devices be in use, the television is likely to be in use, and the power supply to the television should not be interrupted. Further, in some cases, the television remote control may be separate from the STB remote control. Functions such as volume may be controlled only or additionally from the television remote control. Further, the television may have signal inputs independent of the STB, and may be used independently of the STB. Accordingly, the IR sensor may be configured to detect IR signals from remote controls other than the remote control which is used to control the STB. These may be remote controls for any device which requires the television to be on when the device is in use. The IR signals will not control the video functions of the STB, but will serve to reset the countdown timer such that the power to the television is not interrupted.

It may be sufficient to determine that a user is present in the vicinity of the STB in order to decide that the television should not be turned off. Any suitable sensor may be used for determining that a user is present and thus that power to the television should not be interrupted. These include, without limitation, passive IR sensors, ultrasonic sensors, cameras, any other passive or active movement sensors, and sound detectors.

Whatever means is used to determine that the television is on, but not in use, it is unlikely to be completely free of false positives, i.e., determining that the television is not in use when the television is in fact in use. If the television is turned off when a user is in fact still watching a program, the user will be irritated. Repeated occurrences are likely to lead to the power control function of the STB being bypassed, preventing power savings.

The STB includes a warning LED 111. When the STB determines that there has been no IR activity for the set period, the warning LED will flash to alert any user to the imminent shutdown of the power to the television. In the case where there is a false positive, that is, there is a user watching the television, the user may react to observing the flashing of the warning LED by pressing a key on the remote control. The IR signal from the remote control is detected by the IR sensor 101, and the countdown timer is reset, preventing the power to the television being interrupted.

Other methods for warning of imminent shutdown of power to the television may be used. A message may be flashed on the front panel LED display 110. An audible warning tone may sound.

In a preferred version of the invention, a message indicating imminent shutdown, and optionally advising a user what action to take to avoid the shutdown, may be displayed on the television. This is possible because the STB controls the HDMI signal being displayed by the television. The warning message may be displayed by interrupting the television program, or by superimposing the message over the image being played.

Uncontrolled power outlet 109 is optionally provided to allow for power to be supplied to devices which should not have the power supply cut when the television is not in use. This outlet supplies power at all times when the STB is plugged in.

Devices other than a television may be connected along with a television to the Controlled and Monitored outlet 108. In this case, the total load of all devices will be monitored for the characteristics indicating that all devices so connected are in a standby or unused state.

A third type of power outlet (not shown) may be provided. This non-monitored, controlled power outlet is not monitored by the power sensor, so the power drawn by any load connected to the outlet does not contribute to the determination that the monitored load is in a standby or unused state. This outlet is controlled. When power is interrupted to the Controlled and Monitored outlet 108, power is also interrupted to this outlet.

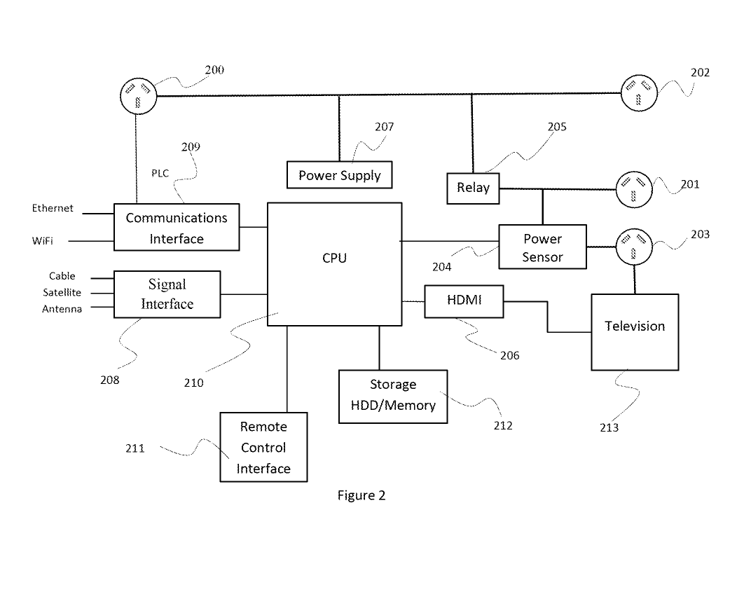

FIG. 2 shows a block diagram representation of an STB incorporating the invention. Mains power is supplied to the STB via plug connection 200. Power is supplied directly to power supply 207, which provides power for the electronic components of the STB. Power is also supplied directly to Always On outlet 202, which is a convenient place to plug in items of equipment requiring uncontrolled access to power. Power is also provided to Controlled power outlet 201 and to Controlled and Monitored outlet 203. The supply of power to these outlets is controlled by relays 205. The characteristics of the power drawn by through the monitored outlet 203 are monitored by power sensor 204. Controlled and Monitored outlet 203 provides power to monitored AV equipment, in this case television 213.

The Signal Interface 208 provides physical connection to an incoming television signal from, without limitation, a cable distribution system, a satellite antenna, or a terrestrial antenna. The incoming signal is provided to processor 210 which decodes the signal to provide a video output signal suitable for display on a television or other monitor. This video signal is output via a video output, in this case HDMI outlet 206 connected to television 213. Any other suitable video output may be used.

There is also provided Communication Interface 209 for two way data communication with the STB. Any suitable data communication means may be provided for, including without limitation, wired ethernet, wi-fi and power line communication. The Communication Interface 209 transmits and receives data communication to and from processor 210.

The STB may also be equipped with a data storage capacity 212 including without limitation, a hard disk drive, electronic memory and USB connected memory.

This version of the invention includes a usage detector, such as a Remote Control Interface 211 which is able to detect usage of one or more remote control devices, preferably infra-red remote control devices.

In use, the Signal Interface 208 provides the television signal to the processor. The television signal is decoded by the processor and output via a video output, in this case the HDMI connection 206 for display on television 213. The television signal may also be received via the Communication Interface 209.

The selection of channel for display, volume etc, is made by a user by use of a remote control. The infra-red remote control signals are detected by Remote Control Interface 211, and the decoded signal passed to the processor. The Remote Control Interface 211 also records receipt of infra-red remote control devices activity which cannot be decoded, which is assumed to be activity of remote control devices of other AV equipment. The occurrence of both types of detected IR is notified to the processor.

In use the STB operates to display the received television signal on the television. The power sensor monitors the power drawn by the television. The power sensor may monitor the current drawn through the Controlled and Monitored Outlet, or both current and voltage may be monitored. Phase angle may also be monitored.

The monitored power draw is used to determine the power state of the television. A significant drop in the magnitude of the power draw can be used to determine that a low power standby mode has been entered. Other characteristics of the power use may be used to determine that the television is not in use. This may be the presence, absence or a defined pattern of small fluctuations of the power draw.

When a determination is made that the television is in a standby state, power to both of the controlled power outlets 201, 203 is interrupted by the operation of relays 205. Power to the Always On outlet 202 is maintained.

The processor receives data from the IR Sensor indicating use of any IR remote control. Where the IR signals are from the STB remote control, or a remote control able to control the STB, the signal is decoded to commands which are carried out by the STB.

The processor determines when no IR activity has been detected for a predetermined period. When this occurs, the processor flashes the warning LED or provides another warning that the television is about to be shut down. If no IR activity is detected in response to the warning, the power to the television is interrupted.

The STB may also enter a low power mode. In such a mode, decoding of the incoming television signal does not take place. Where the STB has a recording function, able to record television programs at a particular time, functionality to ensure that the television signal is received and recorded at the particular time continues.

The processor continues to monitor the IR Sensor. When IR activity is detected, power is returned to the Controlled and to the Controlled and Monitored outlets, and thus power is restored to the television.

In the case where the power to the television is in the interrupted state, the STB will return power to the television when IR is detected. In an alternative version of the invention, the STB may require that the received IR signal is identified as an “ON” command for the television and/or the STB television display function, before returning power to the television. This reduces “false positives” where the STB reacts to an IR source which is other than the user attempting to turn the television on.

The processor may be programmed to keep track of the power consumption of the monitored load, both when the load is using full power and when it is in a low power standby state. Information concerning the number of times the power to the load is interrupted may be recorded. Whether the power was interrupted because the television was in a low power standby mode, or because the television was determined to not be in use may also be recorded. This data may be used to calculate or estimate the energy savings achieved by the STB. This information may be transmitted via the communication interface to an external party such as an energy retailer. The information may also be displayed to a user via an external user interface.

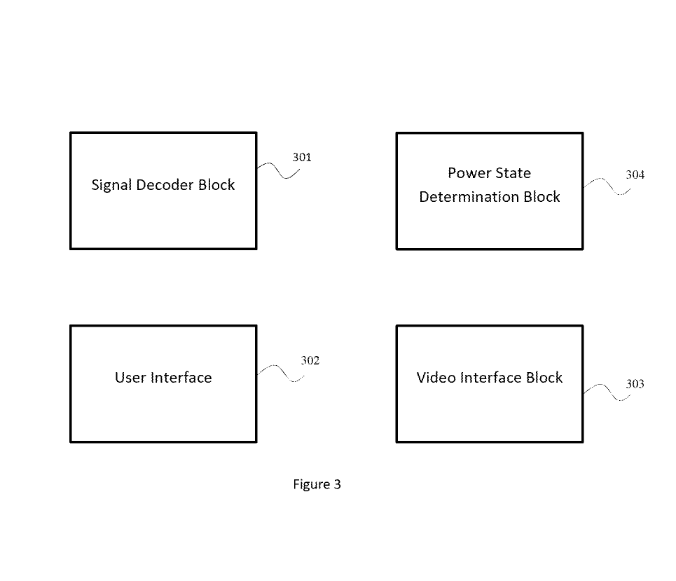

FIG. 3 shows a functional block diagram of the processor of FIG. 2. There is a Signal Decode Block 301 which receives, decodes and outputs the television data.

There is a User Interface (UI) Block 302 which provides for reception of commands from a user, and for the display of information concerning the video display and the power management functions of the STB.

The UI may communicate with a user using any or all of: the front panel of the STB and remote control, the connected television and remote control, and a remote display device such as a computer, including a tablet computer, and a smartphone. Any other suitable means for displaying UI information and receiving user input may be used.

There is a Video Interface Block 303 which controls the display of the video signal from the Signal Decoder Block on an external display such as a television. Where the display device is equipped the Video Interface Block also controls two way data and control communication with the display.

There is a Power State and Usage Determination Block 304 which determines the Power State and Usage of the connected display device, preferably a television set. The Power State and Usage Determination Block receives data from the Signal Decoder Block and the Video Interface Block indicating usage of the video signal, for example, that a video stream is being received by the television. The Power State and Usage Determination Block also receives data from the UI indicating the usage of any infrared remote control. The UI may also be used by a user to set a value for the time period which the Power State and Usage Determination Block should allow to elapse with no indication of remote control use prior to interrupting power to the television. The Power State and Usage Determination Block also receives data from the power sensor indicating the power consumption characteristics of the connected, monitored AV equipment, preferably the television.

The Power State and Usage Determination Block uses the information received to determine when the connected television is in a low power standby state or is otherwise not in use. When such a determination is made, power to the television is interrupted.

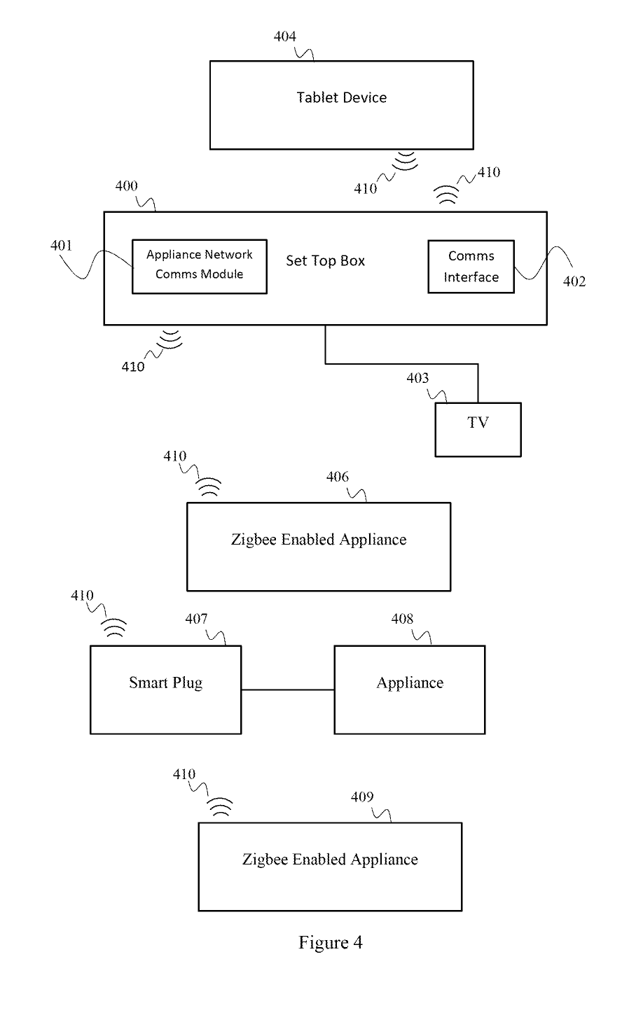

Referring to FIG. 4, there is shown a block diagram of an STB which includes the function of an In Home Display (IHD). In this case it will be advantageous for the STB to have information concerning the total electricity usage of the household. There is provided a Smartmeter 409 which performs the function of metering the electricity usage of the household. The Smartmeter includes a data communication capability which may be provided by any suitable wired or wireless protocol. In a preferred version of the invention the Smartmeter includes Zigbee communication capability 410. The STB also includes the Zigbee communication capability 410. The Smartmeter may be “paired” with the STB via the Zigbee link, enabling the STB to receive data detailing the electrical current flows into (or out of) the premises.

In an alternative version of the invention, there may be provided current measuring devices such as “current clamps” which are placed around the incoming electricity conductors of the premises and which allow the electrical current flowing to (or from) the premises to be measured. The current clamp devices will include a communication capability which permits this information to be made available to the STB.

At its simplest, an IHD displays the current usage of electrical energy by a household to the householder. Commonly, an IHD will also display the cost of this usage. This information may be used by the householder to modify their electricity usage to minimize costs. Any of the user interface functionality of the STB may be used to communicate energy usage and cost to a user.

In the illustrated version of the invention, the STB is in data communication with a tablet computer device 404 via a wi-fi link 412. The tablet device is able to display the electrical usage to the householder. The calculation and computing functions necessary to display this information may be divided between the STB and the tablet device in any convenient manner. The tablet can simply act as a dumb terminal, displaying a video signal provided from the STB. In an alternative version of the invention, the STB supplies only the raw data received from the Smartmeter, with all calculation and display being performed by the tablet device.

The computer device providing the display function may be any suitable device including without limitation a Smartphone, a desk top computer, and a dedicated display device made only for this purpose.

The IHD function may include the display of instantaneous energy usage of at least some energy consuming appliances within the household. The STB has an Appliance Network Communication Module 401. This may include the Zigbee communication capability 410. The STB receives energy usage information from electrical appliances in the household which are capable of communicating such information, such as Zigbee enabled appliance 406.

The STB may also be in communication with smart plug 407. The smart plug is a device which plugs into a general purpose electrical outlet (GPO) and relays power to one or more connected appliances 408. The smart plug is able to measure the power flow being provided to the appliance. Optionally the smart plug may be able to control this power flow. The smart plug includes a communication capability which permits the results of the power measurements to be communicated to the STB. In the illustrated version of the invention, this is via Zigbee communication capability 410, but other communication methods may be used.

The STB provides a video signal to television 403 and may use that video signal to provide the display for the IHD function.

The International Application PCT/AU2013/000236 which is hereby incorporated in its entirety by reference includes a description of a hub device. The functions of a hub may be incorporated into a STB embodying the current invention. This provides cost savings, and improves the ease with which such a hub can be set up, since the required data communications, user interface and data processor are already provided.

The International Application discloses a method for demand management in an energy supply network including receiving a price offer from an energy retailer, the price offer including an offered price and a required consumption change; receiving at least one consumption offer from each of a plurality of consumers, each consumption offer including a consumption change offer and a price requirement; selecting and aggregating at least two of the consumption offers where the price requirement of the selected offers meet the offered price to produce an aggregated consumption offer which includes a consumption change offer being the sum of the consumption change offers of the selected consumption offers which meets the consumption change requirement of the price offer; communicating to the consumers who submitted the consumption offers included in the aggregated consumption offer instructing that the consumption changes included in the selected consumption offers shall be made.

The STB Communications Interface can allow the STB to communicate with corresponding transceivers in or associated with discretionary use appliances in the consumer premises. The STB Communication Interface may include ZigBee protocol capability. ZigBee is widely used for communication with electrical appliances.

Each of the discretionary use appliances includes, or is associated with, a Communications and Control Module (CCM). This CCM includes a transceiver able to communicate with the STB, and means to control, at least in part, the power consumption of the appliance. The nature of this control will be dependent on the nature of the appliance. For appliances such as pool pumps, only simple on/off control may be available. For HVAC equipment, the ability to control a thermostat setting may be included. Where the HVAC equipment has zone controls, these may also be available to the CCM. The CCM is able to communicate the state of the controls to which it has access, to the STB, and to receive instructions from the STB to change the state of those controls. The CCM is also able to determine, and to communicate to the STB, the current power usage of the controlled device.

The user interface of the STB includes functions allowing the consumer to control the hub functionality of the STB. The STB is able to identify, or have identified to it by a user, all of the discretionary use appliances which it is able to control. This includes the nature of the available control in each case, and the power consumption characteristics of the appliance.

The STB is able to connect, via the Communications Interface, to an Offer Aggregation Module (OAM), which is controlled by an aggregator.

An energy retailer is also in communication with the OAM. This communication may be by any means and need not be continuous. In a preferred version of the invention, there is direct data communication between a processing system of the energy retailer and the OAM, but this is not necessary. The communication could be undertaken, without limitation, by other means such as by telephone or text message, with human staff being used at either or both of the energy retailer and the aggregator.

The energy retailer sources the electricity which the consumer, and all of the other customers of the retailer, require from electricity generators via an electricity market, which may take a number of forms.

For technical, commercial and political reasons, it is not generally possible for the energy retailer to implement a price regime where there is a direct, or even an approximate, relationship between the marginal cost per kWh paid by an energy retailer at a given time and the amount being paid by the consumer using that marginal kWh. Thus the wholesale price being paid by the energy retailer for the electricity is for the most part either less than, or very much more than, the price which the consumer is charged for that electricity. This means there is a benefit to the retailer in changing the amount of electricity consumed at a given instant by its customer base. In particular, there is a significant benefit to the retailer in reducing energy consumption at peak times when the retailer is paying far more per kWh than it is able to charge its customers. There is also some benefit in increasing the amount of electricity the retailer is able to sell to its customers at times of low demand, when the retailer is able to buy electricity at prices far below the price charged to the consumer.

The aggregator, via the OAM, facilitates transactions which provide, at least in part, a direct relationship between the cost paid by the energy retailer and the net cost of electricity to the consumer.

When the energy retailer believes that a reduction in consumption of a particular amount would increase the return to the energy retailer, the energy retailer formulates a price offer which is communicated to the OAM. At its most basic, the price offer is an offer of something of value to the consumer in return for a given reduction in electricity consumption for a given period. The value may be in any form including but not limited to reductions in price for electricity for the given period or some other period; direct money payments or bill reductions; goods, discounts on goods or vouchers for goods; services, discounts on services or vouchers for services; loyalty points redeemable for value; any other offer which may be of value. Thus there is an offered price, in return for a required consumption change.

When the STB is installed in the consumer premises and/or at any later stage, the consumer interacts with the STB to indicate what offer the consumer would accept to allow a particular control of the discretionary use appliances, and what limitations would be placed on that. These specifications are termed consumption offers.

For example, the consumer might indicate that any offer would be accepted to allow the pool pump to be turned off, so long as the pump would still run for a minimum specified number of hours for that day. Another specification might be that the air conditioning thermostat may be set one degree higher for a small discount offer, but up to five degrees higher for a large discount offer, but no change would be undertaken for any offer which is not money based. A further specification might be that for a still higher cash rebate, the air conditioner may be turned off, possibly with a limitation that this can only occur if the current temperature is less than a set value.

These consumption offers are communicated to the OAM. The OAM or the STB calculates the reduction in consumption which will occur if the particular consumption offer is taken up. This consumption reduction is recorded as part of the consumption offer. Consumption offers from all consumers who are customers of a particular energy retailer are aggregated by the OAM. This may be done for multiple energy retailers who have access to the OAM.

When the energy retailer issues a price offer, the OAM examines all of the consumption offers which it has received to determine which will be triggered by the price offer, that is, those which have a price requirement less than the price offer. The OAM accumulates the consumption offers, adding the consumption reductions until there is a sufficient reduction to meet the requirements of the price offer. This is the aggregate consumption offer.

When a match is achieved, the OAM communicates acceptance of the price offer to the energy retailer and to the STB having hub functionality at the premises of each consumer whose consumption offer has contributed to the aggregate consumption offer.

The STB at the premises of a consumer whose consumption offer was included in the aggregate consumption offer commands the CCM of each appliance included in the offer to undertake the required action to turn off appliances, reduce thermostat settings or such other activities as were included in the offer.

The STB then monitors the reduction in power use by each of the affected appliances, for the period of time required by the price offer. Compliance or otherwise with the promised reduction in consumption is then reported to the OAM.

The OAM monitors the information returned by each of the hubs, including those incorporated in STBs, to ensure that the consumption reduction included in the aggregate consumption is achieved. This is reported to the energy retailer. When the energy retailer is satisfied that the terms of the price offer have been met, the energy retailer makes available the promise value. Depending on the nature of the value, the energy retailer may provide the value to the participating consumers directly, or may provide it to the aggregator for distribution to the participating consumers.

An aggregate consumption offer may include consumption offers having different price requirements, up to the price of the price offer. This means that some consumers who participate in the accepted offer may not have required the full value of the price offer to participate. The value distributed to a particular participant may be the price requirement set by that particular participant, or the value distributed may be the same for all participants.

In the event that the OAM is unable to produce an aggregate consumption offer that meets the price offer, the OAM may communicate an alternative aggregate consumption offer to the energy retailer. In its simplest form this alternative aggregate consumption offer will be a notification of the total consumption change which would be made at the price offer which the energy retailer has made. Alternatively, it may be an indication of what price offer would be required to achieve the consumption change which is desired. If accepted, this becomes the price offer and the process continues as before. Multiple iterations of price and aggregate consumption offers may occur before a match is made. If no match can be made, no action is taken by either party.

It is expected that the process of offer and counter offer will be made very rapidly, by fully or partially automated systems. However, the aggregator may (when time permits) attempt to form an acceptable aggregated consumption offer by communication of a price offer to consumers via each hub, requesting the consumer to enter modified consumption offers.

In order to facilitate reaching a match, the aggregator may break the price offer down into smaller price offers, each with a consumption requirement and progressively greater price offers, up to the price offer made by the energy retailer. This may be extended to the point where each consumer consumption offer is directly communicated to the energy retailer.

The aggregator may initiate the interaction with an energy retailer, by making an unsolicited aggregated consumption offer. Since the process is expected to be automated, the aggregator may make many simultaneous aggregated consumption offers, each having a different price requirement and consumption offer. Such offers may be made continually or periodically. The consumers, in setting the parameters for the control of the discretionary appliances, may have set time of day requirements or variations based on external variables such as the officially measured temperature. Accordingly, the aggregated offer which the aggregator is able to make will change with variations in time and such external variables.

Although the description has been of an offer requiring consumption decreases, the price offer may be for a consumption increase. The process would proceed in the same manner, but the outcome would be an increase in consumption. Examples of appliances which might be turned on to increase demand would be storage water or space heaters, or pool pumps which had not yet run for the required hours for the day.

The CCM for a particular discretionary use appliance may be integrated into the appliance at manufacture. The STB may include protocols necessary to communicate with the integrated CCM, or the STB may be able to be programmed in the field, including by the CCM, to include the necessary communications protocols. In the illustrated version of the invention, the STB includes the CCM functionality for the television and other connected AV equipment, which is directly controlled by the processor.

The CCM may be completely separate from the controlled appliance and may control it by controlling the power supply to the appliance. The CCM is incorporated into a plug device which is plugged between the device and the GPO (general power outlet) to which the appliance is connected. The CCM monitors the power being drawn from the GPO, and controls the device, on command from the STB, by cutting off the power supply from the GPO.

An alternative energy saving is possible where the video signal protocol used to communicate the video signal to the television (such as HDMI) supports a command, which will hereafter be referred to as the TV Standby command, to put the television or other monitor into a standby mode. Here there is no provision for the power for the television to be provided through the STB, so the television standby mode cannot be detected by the STB by the power characteristics.

The TV Standby command is little used, even where available, because it is not generally possible to be sure that any device sending video to a television is the only device connected to send video to that television. Televisions generally have multiple video inputs which may be connected to appliances such as disc players, video recorders, etc, as well as the STB. In addition, the television is likely to have an inbuilt television signal receiver. Thus no assumption can be made that because the STB is not sending a video signal to the television, that the television is not in use. However, the additional connected devices, and the television, are likely to have infra-red remote controls. Thus the absence of detection of any infra-red signal from any remote control for a specified period by the infra-red sensor 101 may be used to determine with greater confidence that the television is not in use.

When a video signal is not being sent to or received by the television by the STB, and no remote has been used for a period of time, a determination is made that the television is not in use. The warning LED 101 is then caused to flash for a period. If no infra-red remote control use is detected, a TV Standby command is sent. This will cause the television to enter a standby mode, allowing for energy savings.

Where the TV Standby command is available and power is supplied to the television by the controlled power outlet from the STB, as in the device of FIG. 1, the TV Standby command may be issued prior to interrupting power to the television. This has the advantage that the television is not subjected to an unexpected power interruption. Some television sets may include processing and data storage components which may be adversely affected by unexpected power interruption. Providing the TV Standby command allows the television to shut down gracefully and enter a standby state. This change of state may be detected by the power sensor and the power to the television interrupted in response to this detection.

A further refinement is available when the video signal protocol is able to control the standby state of the television. In the case where the STB has interrupted power to the television, the user will normally be required to initiate two IR signals to turn the television on. The first will cause the STB to return power to the television, which will cause the television to be powered, but in most cases it will be in standby mode. The user must then send a further IR signal from the remote control in order to wake the television from standby. Where the power state of the television can be controlled via the video signal connection, the STB, after returning power to the television, will send a command via the video signal connection to the television, causing it to enter the Fully ON state.

Where reference has been made to infra-red remote controls and corresponding infra-red sensors, it will be understood that any form of remote control and corresponding sensors, including, without limitation, radio frequency remote controls, may be employed.

Although the invention has been herein shown and described in what is considered to be more practical and preferred versions, it is recognized that departures can be made within the scope of the invention. The invention is not to be limited to the details described herein, but is to be accorded the full scope of the disclosure so as to embrace any and all equivalent devices and apparatus.

1. A set top box configured to display a video signal on an associated television, wherein the set top box includes:
a. a controlled power outlet configured to provide power for the television; and
b. a switch configured to control power to the controlled power outlet.

2. The set top box of claim 1 further including:
a. a power sensor configured to sense one or more characteristics of the power drawn through the controlled power outlet; and
b. a processor configured to:
(1) determine in which of two power states the television is operating, and
(2) operate the switch in response to the determination.

3. The set top box of claim 2 wherein the processor is configured to operate the switch to remove power from the controlled power outlet when the television is determined to be in a lower power standby mode.

4. The set top box of claim 2:
a. further including a usage detector configured to detect operation of a remote control device,
b. wherein the processor is configured to operate the switch to remove power from the controlled power outlet when the usage detector does not detect remote control activity for a predetermined period.

5. The set top box of claim 4 wherein the usage detector is configured to detect usage of a remote control device which controls the set top box.

6. The set top box of claim 4 wherein the usage detector is configured to detect usage of a remote control device which does not control the set top box.

7. The set top box of claim 4 wherein the usage detector is configured to detect any use of any infra-red remote control.

8. The set top box of claim 4 wherein:
a. the usage detector is configured to analyze a signal from a remote control signal receiver,
b. the remote control signal receiver is configured to receive control signals for controlling the set top box from a remote control, and
c. the remote control is configured to control video display functions of the set top box.

9. The set top box of claim 1:
a. further including a data communication module configured to communicate with an appliance communication module associated with an electrical appliance,
b. wherein the appliance communication module is configured to communicate data describing the usage of the appliance;
c. wherein the set top box is configured to:
(1) receive and process:
(a) data describing the usage and energy consumption of the electrical appliance, and
(b) data concerning the cost of the energy at the time of consumption, and
(2) communicate the result of the processing to a user.

10. The set top box of claim 9 wherein the result of the processing is communicated by a display of a graphical user interface using the television.

11. The set top box of claim 9 wherein the result of the processing is communicated by a display of a graphical user interface provided by a device in data communication with the set top box.

12. The set top box of claim 1:
a. further including:
(1) a sensor which detects IR and/or RF activity from a remote control device, and
(2) a power monitor configured to monitor power consumption of the controlled electrical outlet,
b. wherein the switch is configured to
(1) control power to the controlled power outlet in response to the status of detection of IR and/or RF activity by the sensor,
(2) disconnect the power to the controlled power outlet in response to either of:
(a) the sensor's lack of detection of IR and/or RF activity,
(b) the power monitor's determination that an electrical device connected to the controlled power outlet is in a lower power standby mode.

13. The set top box of claim 1 wherein the set top box is configured to:
a. detect that the television is not in use, and
b. place the television into a lower energy usage state.

14. The set top box of claim 1:
a. further including a data communication module configured to communicate with a communication and control module associated with an electrical appliance,
b. wherein the communication and control module:
(1) communicates data describing the usage of the appliance, and
(2) controls an aspect of the operation of the appliance;
c. wherein the set top box is configured to receive and process:
(1) data describing the usage and energy consumption of the electrical appliance, and
(2) data concerning the cost of the energy at the time of consumption.

15. The set top box of claim 14 wherein the set top box is configured to:
a. determine a mode of operation of the electrical appliance in a manner minimizing the cost of usage of the appliance, and
b. control the communication and control module to effect the determined mode of operation.

16. The set top box of claim 1 wherein:
a. the set top box includes:
(1) an appliance communication module configured to communicate data describing the usage of an electrical appliance;
(2) a data communication module configured to communicate with the appliance communication module;
b. the set top box is configured to:
(1) receive and process data describing the usage and energy consumption of the electrical appliance, and
(2) communicate the result of the processing to a user.

17. The set top box of claim 16 wherein the set top box is further configured to:
a. receive and process data concerning:
(1) the cost of the energy at the time of consumption, and
(2) the total energy consumption of a premises; and
b. communicate the result of the processing to a user.

18. The set top box of claim 16 wherein the result of the processing is communicated by a display of a graphical user interface using the television.

19. The set top box of claim 16 wherein the result of the processing is communicated by a display of a graphical user interface provided by a device in data communication with the set top box.
